(19) United States
(12) Patent Application Publication
(10) Pub. No.: US 2024/0360863 A1
(43) Pub. Date: Oct. 31, 2024

(54) FASTENER SEALANT CAPSULE

(71) Applicant: Pegasus Solar, Inc., Richmond, CA (US)

(72) Inventors: Ian Wogan, Richmond, CA (US); Erich Kai Stephan, Richmond, CA (US)

(21) Appl. No.: 18/649,950

(22) Filed: Apr. 29, 2024

Related U.S. Application Data
(60) Provisional application No. 63/462,921, filed on Apr. 28, 2023.

(51) Int. Cl. F16B 33/00

(52) U.S. Cl. CPC F16B 33/004

(57) ABSTRACT

A capsule for delivering sealant for fastener is disclosed. A capsule includes a cavity that contains an amount of sealant, a perimeter wall and a top cap that define the cavity, where the top cap is configured align with an interior contour of the perimeter wall and collapse through the perimeter wall; and one or more breakaway tabs disposed on the perimeter wall, wherein the breakaway tabs are configured to resist a release of sealant within the cavity.

### CROSS-REFERENCE TO RELATED APPLICATION

This application claims priority benefit of U.S. provisional patent application No. 63/462,921, the disclosure of which is incorporated by reference herein.

### BACKGROUND OF THE CLAIMED INVENTION

### 1. Field of the Disclosure

The present disclosure is generally related to preinstalled sealant for fasteners.

### 2. Description of the Related Art

Currently, fasteners that are installed onto an installation surface that require a water-tight barrier typically utilize a gasket or washer for creating a water or vapor barrier. These methods can result in sub-optimal sealing against an uneven surface. Alternatively, the fasteners may utilize a hardening sealant or adhesive that is applied during installation. However, this method is subject to user-error and inconsistency. The present invention solves these deficiencies through a preinstalled sealant that conforms an uneven installation surface.

### BRIEF DESCRIPTION OF THE DRAWINGS

These drawings depict only exemplary embodiments of the disclosure and are not therefore to be limiting of its scope. The principles herein are described and explained with additional specificity and detail through the use of the accompanying drawings in which:

FIGS. 1A and 1B respectively depict isometric upper and lower views representing an example embodiment of the present invention.

FIGS. 2A and 2B depict isometric upper and lower views representing an example embodiment of the present invention.

FIG. 3 depicts isometric view of the capsule in a preinstalled state representing one example of the present invention.

FIGS. 4 and 5 respectively depict an isometric view of the capsule in an installed state representing one example of the present invention.

FIGS. 6 and 7 respectively depict an underside view of a single sealant flow cavity when a capsule is in a preinstalled state and when a capsule is partially in a installed state representing one example of the present invention.

FIGS. 8A through 8D depict an alternative embodiment of the capsule wherein the capsule has a protective cover on the underside representing one example of the present invention.

FIGS. 9A through 9D represent the capsule installed onto an alternative embodiment of a base representing one example of the present invention.

FIGS. 10A through 10C depict various views of an alternative mount both with and without one or more capsules installed representing one example of the present invention.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

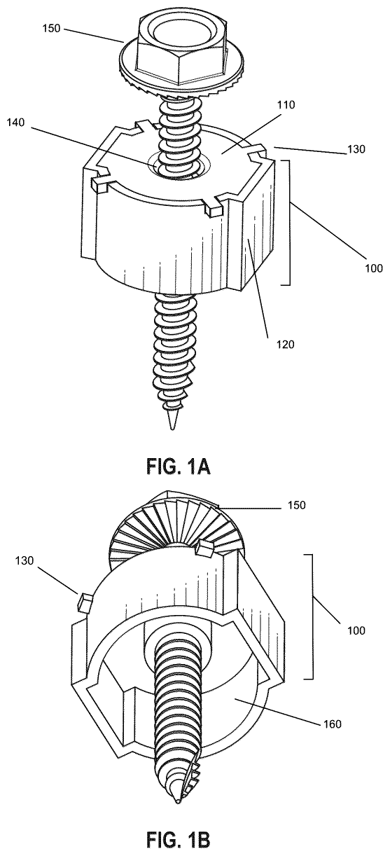

FIGS. 1A and 1B are isometric views representing an example embodiment of the present invention. Capsule 100 may consist of a perimeter wall with top cap 110 configured to collapse through the perimeter wall 120. The perimeter wall 120 and top cap 110 may define a cavity 160 inside the capsule. Capsule 100 may be a cylindrical shape, a conical shape, a rectangle, square, hexagon, complex shape, or another suitable shape. The top cap may be configured to align with the interior contour of the perimeter wall 120 such that it may traverse through the perimeter wall 120 with a minimal gap around its edges. The top cap 110 may have one or more break-away tabs 130 disposed around its perimeter in order to retain the top cap in a first position at one distal end of the perimeter wall 120. The top cap 110 may be a separate component from the perimeter wall, or both parts may be formed as a single component. An aperture 140 may be disposed in the center of the top cap 110 and configured to receive a fastener 150. The top cap 110 may also have a cylindrical body cordial to the aperture and protruding in towards the center of the capsule. The cylindrical body may be configured to help align the body of the fastener with the capsule.

In other embodiments not shown, a mesh or grid surface with a plurality of apertures may be disposed across the opening of the capsule 100 on the opposite end of the top cap 110. The apertures and mesh may be configured to allow for a sealant to flow through the apertures, but prevent foreign objects from entering the capsule, such as a finger.

A measured amount of sealant may be disposed inside the cavity 160 of the capsule 100. An initial preinstalled state may be defined as a capsule 100 with sealant disposed on the interior of the capsule 100, and a fastener 150 positioned through an aperture, such as a centrally located aperture 140. In the preinstalled state, the top cap 110 may be positioned along the length of the perimeter wall 120 such that the sealant is substantially fully within the cavity. When the fastener 150 is engaged to an installation surface, such as threadably engaged, then fastener 150 may cause the top cap 110 to traverse through the body of the perimeter wall, pushing the sealant out of the opposite side of the capsule and onto the installation surface. When the top cap has traversed a sufficient distance, such as when the top cap is substantially coincident with a mesh surface or the installation surface and a desired amount of sealant has been pushed out of the capsule, the capsule may be in an installed state.

One or more break-away tabs 130 on top cap 110 may have a sufficient strength so that the capsule 100 does not transition out of a preinstalled state by hand pressure, during shipping or handling to an installation surface, or before the desired time when the fastener 150 is engaged with the installation surface. For example, break-away tabs 130 may be able to withstand a force just below the force required to strip the fastener threads in an installation surface. In another example, the downward force on top cap 110 necessary to fracture break-away tabs 130 and allow the capsule to transition from a preinstalled state to an installed state may be 5 to 200 pounds-force.

In another example embodiment not shown, the top cap may not be a separate component, but rather the underside flange on a fastener may act as the top cap. In this example, a perimeter wall may follow the exterior contour of a flange on the fastener, such as a circular shape. The perimeter wall and the flange of the fastener thus define the cavity inside the capsule. The perimeter wall may have one or more flanges configured to retain the fastener in a preinstalled state. When the fastener is threadably engaged to the installation surface, the force pulling the fastener towards the installation surface due to the thread engagement may overcome the retention forces of the flanges, thereby allowing the fastener to traverse through the body of the perimeter wall (e.g. through the cavity) to an installed state, such as when the fastener is seated against the installation surface or a mesh on the capsule.

Capsule 100 may be made from a polymer, aluminum, rubber, steel, plastic, or other suitable material. The capsule may be manufactured using processes such as injection molding, blow molding, die casting, investment casing, cold heading, progressive die stamping, deep draw stamping, additive manufacturing, 3D printing, or other suitable methods. The walls of the cylindrical body may have a tapered cross section in order to aid in the manufacturing process. In other words, the wall thickness at one distal end of the perimeter wall, such as where the top cap resides, may be thinner than the wall thickness at the opposite end of the perimeter wall.

Not shown, the capsule may have one or more connection flanges configured to lock the capsule onto a body, such as a plate on a mounting bracket. The connection flanges may be at the distal end of the perimeter wall opposite where the top cap resides. The connecting flanges may have a barbed end to aid in the installation and connection of the capsule to a body while preventing the capsule and body from readily disconnecting.

The sealant may have a prescribed volume disposed on the surface, controlled, for example, by an electronic, pneumatic, or hydraulic dispenser. In another application process, the sealant may be disposed using a manual process, such as using a caulking tube or syringe. The sealant may be disposed to form a substantially desired, or programmed, shape, thickness, width, or curvature, to achieve a desired volume.

The sealant consists of a substance meant to prevent water from accessing a penetration where a fastener 150 is located on an installation surface. Additionally, the sealant may have characteristics to fill voids or cracks on the underlying installation surface, such as a gap between asphalt shingles, or to fill vacant holes in a roof surface such as unused pilot holes. The sealant may have properties of being waterproof, water resistant, weatherproof, or to repel water. In other example embodiments of the present invention, the sealant may be an isobutylene compound, a butyl-based rubber sealant, a non-skinning or minimally skinning sealant, a non-sag or minimally-sag sealant, or a combination thereof. The sealant may have a defined viscosity or ingress protection rating to prevent the sealant from readily flowing beyond the interior cavity of the capsule 100 when the capsule 100 is in any orientation (such as a bulk packed package) in elevated temperatures, such as 190 degrees Fahrenheit, while also having a viscosity that still allows the sealant to flow around a fastener or through a mesh or into voids on the installation surface in colder temperatures when being installed, such as when installing on a sub-freezing exterior building surface. The sealant may have properties of being permanently or semi-permanently flexible, maintain a permanent or semi-permanent surface tack, be self-healing, or a combination thereof. In another example embodiment of the present invention, the sealant may have desired time period, such as 1-year, to maintain a desired flexibility, maintain a surface tack, be self-healing, or a combination thereof. The sealant may maintain flexibility at low temperatures, and may be designed to perform in its intended use, transitioning from a Preinstalled to an installed state, in temperatures ranging from −40 degrees to over 200 degrees Fahrenheit. The sealant may flow through the capsule from the force of the fastener being installed without the fastener damaging the installation surface, such as the fastener threads stripping a wood material in the installation surface. The sealant may have a specific color, such as off-white, dark gray, or blue, such as for the purpose of visually blending into the average hues and colors of the installation surface, or visually contrasting with the average hues and/or colors of the installation surface or a capsule. Alternatively, the sealant may intentionally have a color that contrasts with the color of the capsule and or installation surface in order to readily provide visual confirmation of the capsule transitioning between a Preinstalled to an installed state if sealant ejects outside of the perimeter, edge, or surface of the capsule or mount such that a portion of the sealant is visible to the person installing. The sealant may be a non-hardening sealant, maintaining a liquid or semi-liquid state for a prolonged period of time, such as 1-year, 10-years, or indefinitely. The sealant may have a low viscosity, or have a cure time greater than 1, 5, or 10 years, or may never cure. The sealant may have an asymptomatic cure time, wherein it hardens over time but never fully cures. In other words, the sealant may increase in viscosity, decrease in flexibility, decrease in tack, decrease in adhesion, or change state, or a combination thereof over time. The sealant may remain tacky for an extended period of time, such as 10 or 30 years, such that the sealant will maintain a water-resistant barrier with the installation surface. The sealant may have a chemistry to be compatible with a variety of building materials, such as asphalt, composite asphalt, composite shingle, tar paper, roofing paper, tar roof, TPO, PVC, Hypalon, Kynar, painted metal, fiberglass, stone-coated steel, clay, ceramic, glass, concrete, cement, fiberglass, glass, acrylic, gelcoat, aluminum, steel, stainless steel, wood, and other common building materials. The sealant may reduce in viscosity at temperatures above the room temperature, with one purpose being to more readily disperse a bead of sealant onto the underside of the mount during assembly, e.g. when applying the sealant into the cavity of the capsule 100.

The fastener 150 may have a thread size under ¼-inch in diameter but have a hex head sized and configured to receipt a standard ½-inch socket. The fastener 150 may have a flanged head, and the flange may have serrations disposed on the underside. A hex-socket, or a hexalobular socket cavity may be disposed in the top surface of the head of the fastener configured to receive a hex or a hexalobular tool. Fastener 150 may have a self-tapping point for cutting into the material of the installation surface.

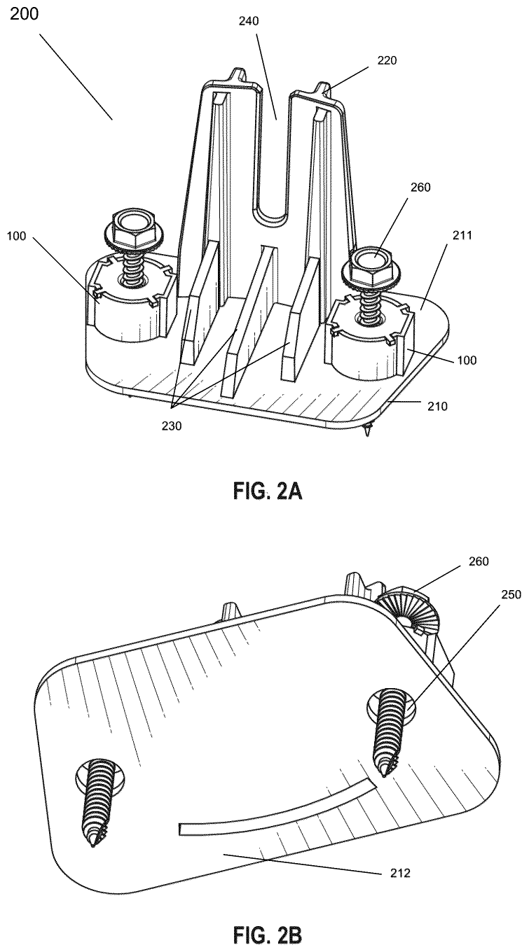

FIGS. 2A and 2B depict a plurality of capsules 100 disposed on the surface of a mount 200, representing one example of the present invention. In FIG. 2A, mount 200 is depicted with a substantially flat body 210. A main flange 220 may extend substantially orthogonal to the body 210, and one or more ribs 230 may be disposed on the body connecting to the main flange. An enclosed or an open aperture 240 (as depicted) may be disposed through the main flange 220. On the surface of body 210, depicted are two capsules 100, with the side opposite the top cap substantially coincident with the top surface of the body 210. The body 210 may have two primary surfaces, a top surface 211 and an oppositely positioned bottom surface 212. The bottom surface may be substantially flat, or may variously shaped cavities disposed around a fastener aperture 250. Disposed on the body may be one or more fastener apertures 250 configured to allow a fastener 260 to traverse through the body. Not depicted, additional apertures or flanges or protrusions may be disposed on the body and configured to connect with connection flanges on the capsule.

In an alternative embodiment of the present invention not shown, the perimeter wall of the capsule may be formed into the body of the mount. In this example embodiment, the perimeter wall may be substantially centered, such as coincident, with a fastener aperture disposed on the body of the mount. A top cap may be a separate component, such as a stamped metal sheet or a plastic or polymer piece. In this example embodiment, the cavity is defined as the volume of area between the perimeter wall, the top surface of the body of the mount 200, and the underside of a to-be installed top cap. The sealant may be installed into the cavity before the top cap is installed onto the capsule. Once the sealant is installed, such as through a robotic process previously described, then the top cap may be placed to cover the cavity. The top cap may connect onto the perimeter wall through a snap feature, interference fit, the break-away tabs, or similar method in order to prevent the top cap from readily traversing through the perimeter wall until a sufficient force is applied to the top cap. This force may be an amount less that the force that would cause the threads on a fastener to strip when installed into an installation surface. When the capsule transitions to an installed state, the top cap will have pushed the sealant through the fastener aperture in the body of the mount and between the installation surface and bottom surface of the body.

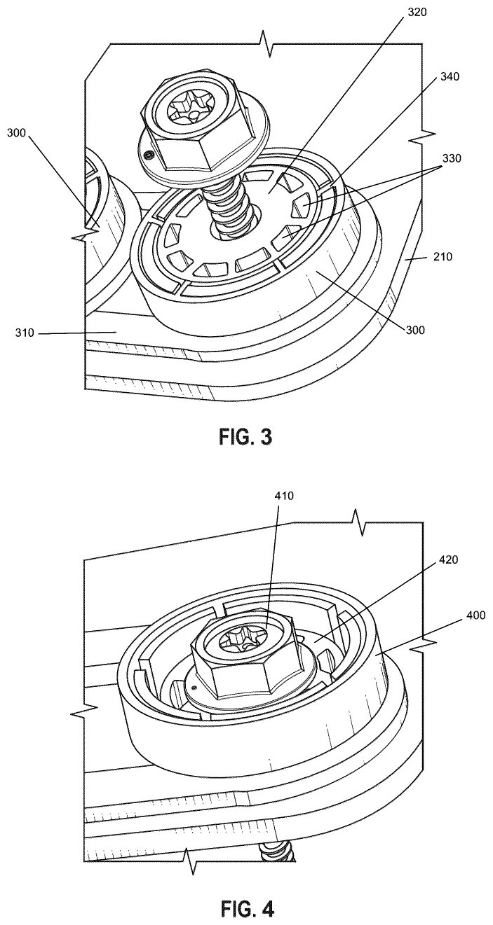

FIG. 3 depicts a body 210 without a main flange, and one or more capsules 300 may be disposed on the top surface of the body 210, representing another example of the present invention in a preinstalled state. As depicted, two capsules 300 are adjoined by a horizontal member 310 in order to create a single-piece double-capsule. In this example embodiment, the top cap 320 has a series of cavities 330 disposed across its top surface for reducing material used in manufacturing. In other embodiments, additional capsules may be adjoined through one or more horizontal members or ribs or flanges to create a poly-capsule. The perimeter walls, capsules, top caps or horizontal members may have engagement features to aid in the robotic assembly of the components. The engagement features could be apertures, flanges, grooves, slots, indentations, curvatures, tapered wall sections, varying textures, or other features to suitably enable robotic or semi-automated assembly of the various components.

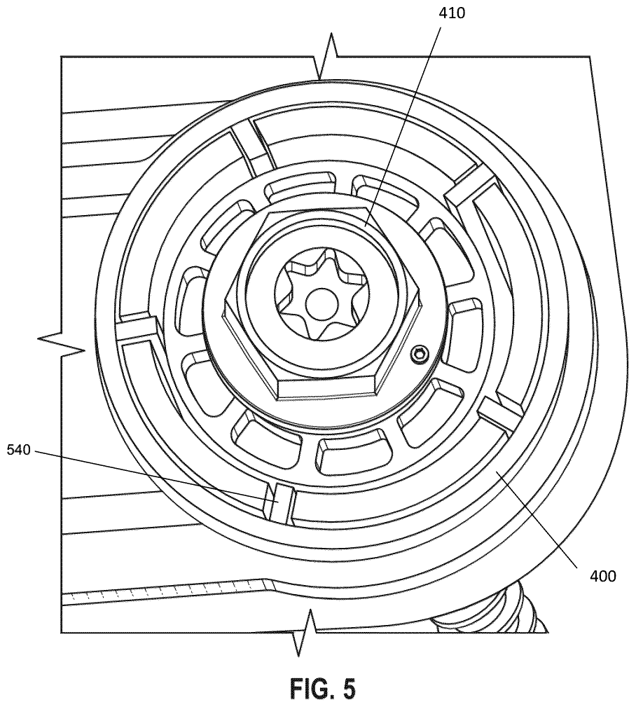

FIGS. 4 and 5 depict capsule 400 in an installed state. In this example embodiment, the fastener 410 has applied a sufficient force onto the top cap 420 to fracture the breakaway tabs 540 (or 340 as shown in FIG. 3), thereby causing the top cap 420 to traverse with the head of the fastener through the perimeter wall of the capsule and forcing the sealant through one or more apertures in the body of the mount.

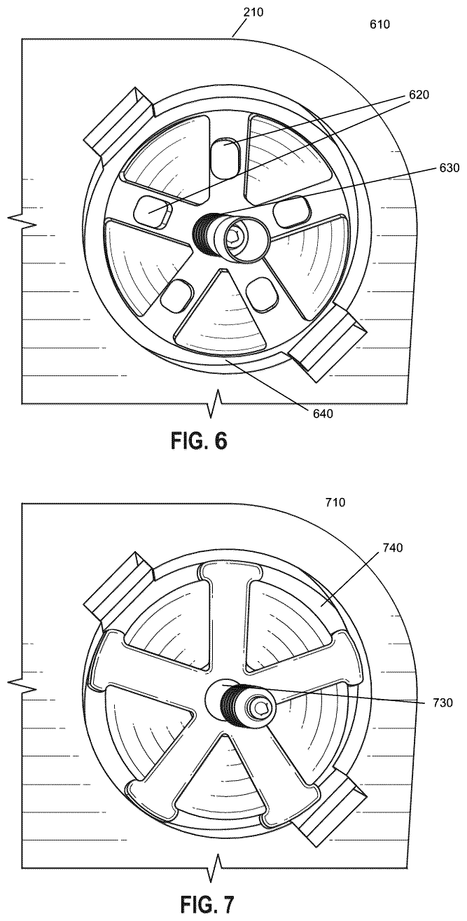

FIGS. 6 and 7 are close-up depictions of a single sealant flow cavity 610 or 710 disposed on the underside surface of the body 210, representing one example embodiment. FIG. 6 depicts when the capsule is in a preinstalled state and the sealant is visible through one or more sealant ports 620. FIG. 7 depicts the capsule partially transitioned from a preinstalled state to an installed state, where the sealant has partially injected out of the capsule and partially into the sealant flow cavity 610 or 710. In this example embodiment, As depicted, on or more sealant ports 620 are disposed near the fastener and within the footprint of the perimeter wall, sealant is visible through the sealant ports 620, the sealant flows through the passageways connecting the fastener aperture 630 or 730 to the perimeter aperture 640 or 740. In this example, the sealant flow cavities 610 or 710 are a circular shape around the fastener, with a plurality of passageways connecting the fastener aperture to a perimeter passageway. In other embodiments, the sealant flow cavity may be a single large cavity, a domed shape, rectangular shape, polygon shape, or other profile to suitably direct the sealant around a fastener to prevent water ingress reaching the fastener. The sealant flow cavity may be a complex singular or series of passageways, such as a “U”, “S”, “C” or other suitable shape.

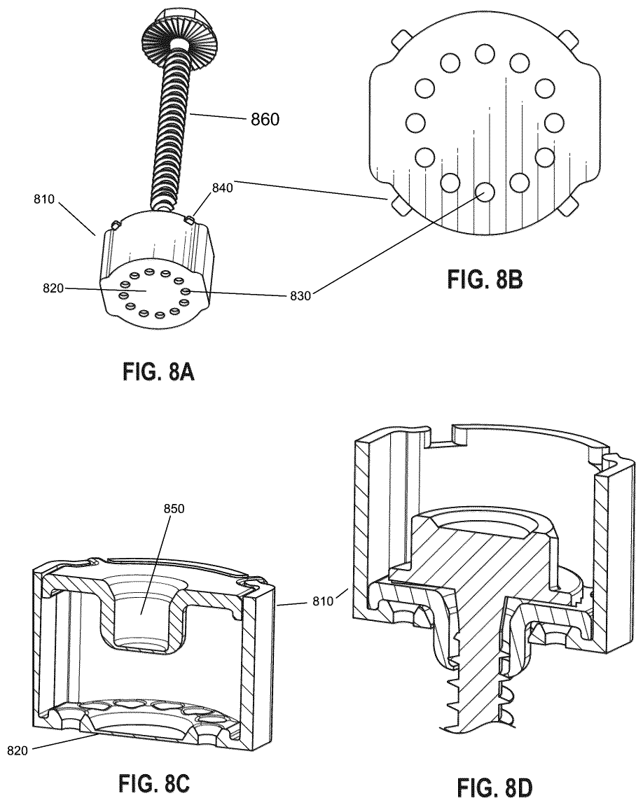

FIGS. 8A through 8D depict an alternative embodiment of capsule 810 with a protective cover or protective plate 820 disposed across one end of perimeter wall opposite from the top cap, representing another example of the present invention. In this example embodiment, the top cap has one or more protrusions 840 formed in its main surface that are configured to traverse through a like-shaped perimeter wall, wherein the protrusions 840 prevent the top cap from readily rotating around the primary axis of the fastener 860 as the fastener 860 is tightened to the roof. One or more apertures 830 may be disposed across the surface of the protective plate 820 and configured to allow the sealant to flow through when the capsule 810 is transitioned to an installed state. The top cap may have a downwardly protruding cylinder with an interior cavity 850 configured to receive the tip of a fastener and to help align the faster with the main body of the capsule 810. The protective plate 820 may have a thin cross section positioned underneath the cylindrical protrusion in the top cap with a strength sufficient to prevent readily breaking. However, the cross section may be thin enough so that it can be penetrated through by the cylindrical protrusion and fastener 860 when the capsule 810 is transitioned from a preinstalled state to an installed state.

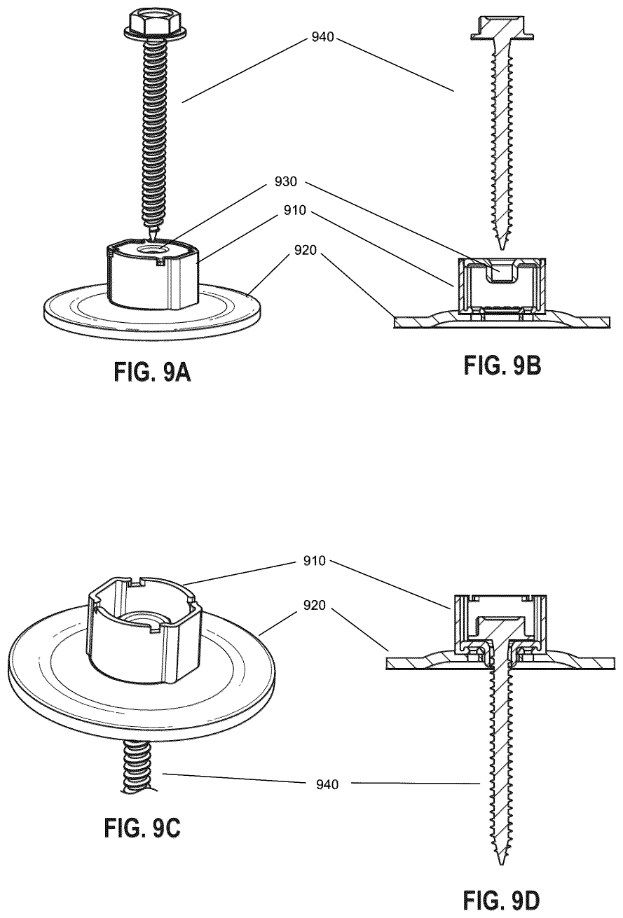

FIGS. 9A through 9D depict a capsule 910 installed on alternative embodiment of the base 920 representing and different example embodiment of the present invention. FIGS. 9A and 9B represent preinstalled state, whereas FIGS. 9C and 9D represent installed state. In this example the base 920 is a cylindrical form that has a dome shaped sealant flow cavity disposed on the underside surface. A fastener aperture 930 is located in the center of the dome and configured to receive a fastener 940. Capsule 910 is secured to the base 920 with one or more flange, clip, snap, adhesive thread or other suitable method. In this example embodiment the base may be formed out of a stamped piece of metal or an injection molded polymer or similar process.

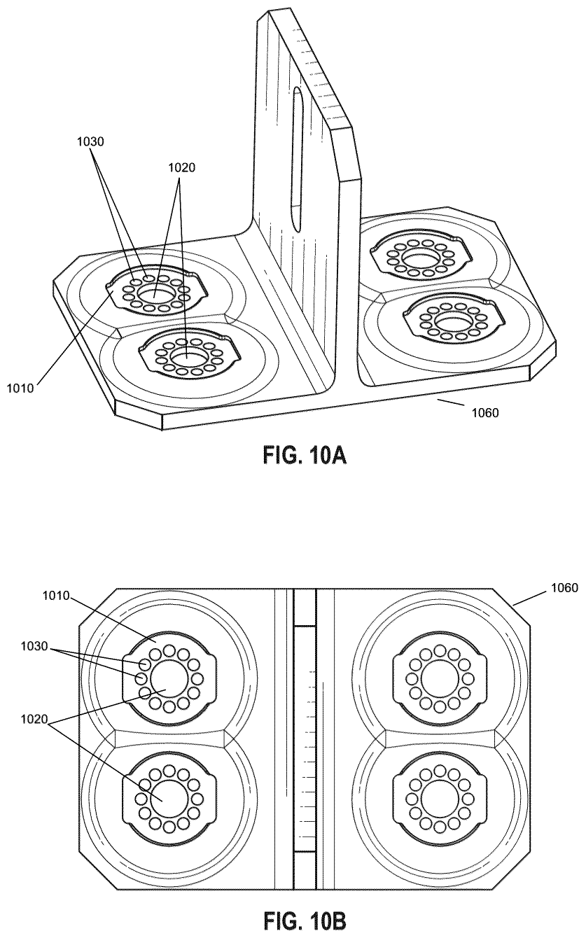

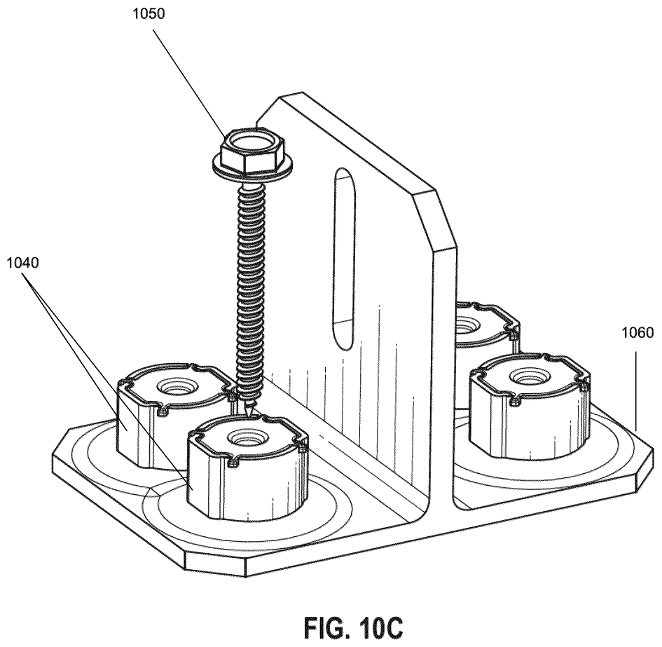

FIGS. 10A through 10C depict an Alternative embodiment of the present invention where the base 1010 has one or more fastener apertures 1020 that have formed proximally one or more sealant ports 1030. In this example embodiment the sealant flow cavity may be a domed shape with a centrally located fastener aperture. One or more sealant ports may be disposed proximal and around the fastener aperture. FIGS. 10A and 10B depict the mount without any capsules installed. FIG. 10C depicts mount 1060 with a plurality of capsules 1040 installed and an exemplar fastener 1050 positioned over one of the capsules 1040. In this example embodiment mount 1060 may be formed using a diecast, investment cast, extrusion, additive manufacturing, stamped, or other suitable manufacturing process. One or more capsules may be filled with sealant and then may be robotically secured to the top surface of the base as a final assembly.

In an alternative embodiment of mount 1060 pictured in FIG. 10A, the plurality of locations where a capsule is installed are disposed in a diamond pattern around the main flange of the mount. The main flange of the mount may be offset from the center line as depicted and may have one or more ribs or gussets connecting the main flange to the base. Two of the capsule positions may be aligned with the slot aperture in the main flange. In the top surface of the base a recession may be formed that substantially outlines the shape of the capsule. This recession is configured to receive a capsule and may help prevent it from readily rotating around the primary axis of the fastener.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A capsule apparatus for delivering sealant for fasteners, the capsule apparatus comprising:
a perimeter wall;
a top cap aligned to an interior contour of the perimeter wall, wherein the perimeter wall and the top cap define a cavity during an initial state; and
a fastener configured to be disposed through an aperture of the top cap, wherein engaging the fastener to an installation surface causes the top cap to traverse along a length of the perimeter wall and transition from the initial state to an installed state, and wherein the top cap traversing along the length of the perimeter wall pushes sealant disposed within the cavity towards the installation surface.

2. The apparatus of claim 1, wherein the top cap includes one or more breakaway tabs configured to be disposed on the perimeter wall, wherein the breakaway tabs are configured to withstand an amount of force during the initial state and to fracture under a greater amount of force.

3. The apparatus of claim 1, wherein the sealant is butyl-based compound.

4. The apparatus of claim 1, wherein the top cap is a flange corresponding to the fastener.

5. The apparatus of claim 1, further comprising a protective cover at an opposite end of the perimeter wall from the top cap, wherein the protective cover includes one or more apertures configured to allow the sealant to flow through when the sealant is pushed towards the installation surface.

6. The apparatus of claim 1, wherein the sealant flows toward the installation surface upon being pushed by the traversal of the top cap at one or more temperatures above zero degrees Fahrenheit.

7. The apparatus of claim 1, wherein the sealant does not flow toward the installation surface at one or more temperatures below 170 degrees Fahrenheit until being pushed by the traversal of the top cap.

8. The apparatus of claim 1, wherein the fastener does not damage the installation surface when the fastener engages to the installation surface using an amount of force sufficient to cause the top cap to traverse along the length of the perimeter wall.

9. A system of delivering sealant for fasteners, the system comprising:
one or more capsules, wherein each capsule includes a cavity within an amount of sealant may be disposed; and
a mount that includes:
a mount body that that includes one or more fastener apertures, wherein the one or more capsules are disposed on the mount body; and
one or more sealant flow cavities that allows sealant to flow from the fastener apertures to one or more sealant ports.

10. The system of claim 9, wherein the sealant is butyl-based compound.

11. The system of claim 9, wherein at least one of the capsules further includes a top cap aligned to an interior of the capsule.

12. The system of claim 11, wherein the top cap includes one or more breakaway tabs configured to fracture at an amount of force.

13. The system of claim 11, wherein the top cap is a flange corresponding to the fastener.

14. The system of claim 11, wherein at least one of the capsules further includes a protective cover at an opposite end of the perimeter wall from the top cap, wherein the protective cover includes one or more apertures configured to allow the sealant to flow through when the sealant is pushed towards the installation surface.

15. The system of claim 9, wherein the sealant flows toward the installation surface upon being pushed at one or more temperatures above zero degrees Fahrenheit.

16. The system of claim 9, wherein the fastener does not damage the installation surface when the fastener engages to the installation surface using an amount of force sufficient to cause the top cap to traverse along the length of the perimeter wall.

17. A method for installing a fastener sealant capsule, the method comprising:
disposing an amount of sealant within a cavity defined by a perimeter wall and a top cap aligned to an interior contour of the perimeter wall and positioned along a length of the perimeter wall during an initial state;
positioning a fastener through an aperture of the top cap; and
engaging the fastener to an installation surface, wherein engaging the fastener to the installation surface causes the top cap to traverse along the length of the perimeter wall, and wherein the top cap traversing along the length of the perimeter wall pushes the sealant towards the installation surface.

18. The method of claim 17, wherein the top cap includes one or more breakaway tabs configured to be disposed on the perimeter wall and to withstand an amount of force during the initial state and to fracture under a greater amount of force, and wherein the fastener is engaged to the installation surface using the greater amount of force.

19. The method of claim 17, wherein the top cap is a flange corresponding to the fastener.

20. The method of claim 17, wherein the sealant is butyl-based compound.

21. The method of claim 17, further comprising positioning a protective cover at an opposite end of the perimeter wall from the top cap, wherein the protective cover includes one or more apertures configured to allow the sealant to flow through when the sealant is pushed towards the installation surface.

22. The method of claim 17, wherein engaging the fastener to the installation surface with an amount of force pushes the sealant to flow toward the installation surface at one or more temperatures above zero degrees Fahrenheit.

23. The apparatus of claim 17, wherein the sealant does not flow toward the installation surface at one or more temperatures below 170 degrees Fahrenheit until being pushed by the traversal of the top cap.

24. The method of claim 17, wherein the fastener is engaged to the installation surface using an amount of force sufficient to cause the top cap to traverse along the length of the perimeter wall, and wherein the fastener does not damage the installation surface when the fastener engages to the installation surface using the amount of force.
